(19) United States
(12) Patent Application Publication
(10) Pub. No.: US 2013/0101143 A1
(43) Pub. Date: Apr. 25, 2013

(54) MICRO-ELECTRO-MECHANICAL SYSTEM MICROPHONE CHIP WITH AN EXPANDED BACK CHAMBER

(71) Applicants: Hung-Jen CHEN, Taichung (TW); Kuan-Hsun Chiu, Taichung (TW); Chun-Chieh Wang, Taichung (TW); Ming-Li Hsu, Taichung (TW)

(72) Inventors: Hung-Jen CHEN, Taichung (TW); Kuan-Hsun Chiu, Taichung (TW); Chun-Chieh Wang, Taichung (TW); Ming-Li Hsu, Taichung (TW)

(21) Appl. No.: 13/278,558

(22) Filed: Oct. 21, 2011

(51) Int. Cl. H04R 1/00

(52) U.S. Cl. 381/174

(57) ABSTRACT

A MEMS microphone chip with an expanded chamber comprises a base plate, and the base plate has a main chamber and a secondary chamber. The secondary chamber is formed beside the main chamber, and is connected to the main chamber. A vibration membrane is suspended above the main chamber for receiving external sound waves, and the vibration membrane vibrates in corresponding to the chambers. The MEMS microphone chip has a higher sensitivity because of the expanded chamber, and therefore has a more ideal audio frequency response curve.

### BACKGROUND OF THE INVENTION

1. Field of Invention

The present invention relates to micro-electro-mechanical system(MEMS) microphone chip and more particularly to a MEMS microphone chip with an expanded chamber besides an original chamber, and the two chambers are connected to each other.

2. Related Art

In the wake of rapid development of semi-conductor technology, electronic products are becoming slimmer and more compact in design than ever before. The integration of microphones in semi-conductor industry to convert sound waves into electronic signals is the faster developing technology in the electroacoustic field. Many electronic products found in the market today are installed with MEMS microphones, which are more heat-resistant, anti-vibrational, and radio frequency interference (RFI) resistant than conventional electret condenser microphones (ECM) which are widely used. Because of its better heat-resistant characteristic, thus the MEMS microphone can be manufactured by automatic surface mount technology (SMT) which can simplify production procedures, reduce production costs, and can also allow free designs and reduce system costs.

Referring FIG. 1, it shows a cross-sectional view of a conventional MEMS microphone chip. The MEMS microphone chip is formed in this way: A silicon oxide insulating layer 11 and a silicon nitride insulating layer 12 are formed on a silicon base plate 10 by micro electromechanical manufacturing process; a vibration membrane layer 13 and an electrode 14 are formed on the silicon nitride insulating layer 12, wherein a conducting wire 15 is electrically connected between the vibration membrane layer 13 and the electrode 14; furthermore, a chamber 16 is formed in the silicon base plate 10 by etching, so that the vibration membrane layer 13 is suspended on the silicon nitride insulating layer 12; the conventional microelectromechanical microphone chip can be disposed on a bottom plate, and electrically connected to a semi-conductor chip (ASIC—Application Specific Integrated Circuit) on the same bottom plate; then a MEMS microphone is assembled after the bottom plate is fitted with an outer case with sound holes. The vibration membrane layer 13 vibrates in response to external sound waves which are transmitted to the MEMS microphone chip through the sound holes; then an electronic signal is correspondingly produced and is transmitted to the semi-conductor chip via the electrode 14, it is then output to a processor of an electronic product installed with the MEMS microphone.

The space of the chamber 16 formed in the silicon base plate 10 is very small because of the micro-sized MEMS microphone chip, thus the vibration force of the vibration membrane layer 13 is reduced due to the air resistance produced by the limited space of the chamber 16. This causes the deterioration of sound quality of the MEMS microphone, especially in terms of sensitivity.

### SUMMARY OF THE INVENTION

In order to tackle the problems mentioned above, an object of the present invention is to provide an additional chamber besides the original chamber on the base plate; from an appropriate part of the base plate, the additional chamber is extended from and connected to the original chamber, so that the space of the original chamber is expanded and the efficiency is enhanced without adding other structures.

In order to achieve the above mentioned object, a microelectromechanical microphone chip with an expanded chamber of the present invention comprises a base plate, and the base plate has a main chamber and a secondary chamber. The secondary chamber is formed beside the main chamber, and is connected to the main chamber. A vibration membrane is suspended above the main chamber. When the vibration membrane receives external sound waves and vibrates in corresponding to the chambers, an electronic signal is correspondingly produced and transmitted to an electronic circuit which is electrically connected to the microelectromechanical microphone chip, in order for the electronic signal to be read.

In view of the abovementioned, by the simultaneous forming of the main chamber and the secondary chamber on the base plate, a MEMS microphone chip with an expanded chamber of the present invention can expand a chamber of a conventional MEMS microphone chip, without increasing the overall size of the MEMS microphone chip, and without the arrangement of other structures; in such a way that, the MEMS microphone chip can show better sensitivity when it is installed in a MEMS microphone, and therefore has a more ideal audio frequency response curve.

The present invention will become more fully understood by reference to the following detailed description thereof when read in conjunction with the attached drawings.

### BRIEF DESCRIPTION OF THE DRAWINGS

FIG. 1 is a cross-sectional view of a conventional MEMS microphone chip;

FIG. 2A is a cross-sectional view of a MEMS microphone chip of the present invention;

FIG. 2B is a top partial transparent view of FIG. 2A;

FIG. 3 is a schematic view of manufacturing process of another embodiment of a MEMS microphone chip of the present invention;

FIG. 4A is another schematic view of manufacturing process of another embodiment of a MEMS microphone chip of the present invention;

FIG. 4B is a top partial transparent view of FIG. 4A;

FIG. 5A is yet another schematic view of manufacturing process of another embodiment of a MEMS microphone chip of the present invention; and

FIG. 5B is a top partial transparent view of FIG. 5A.

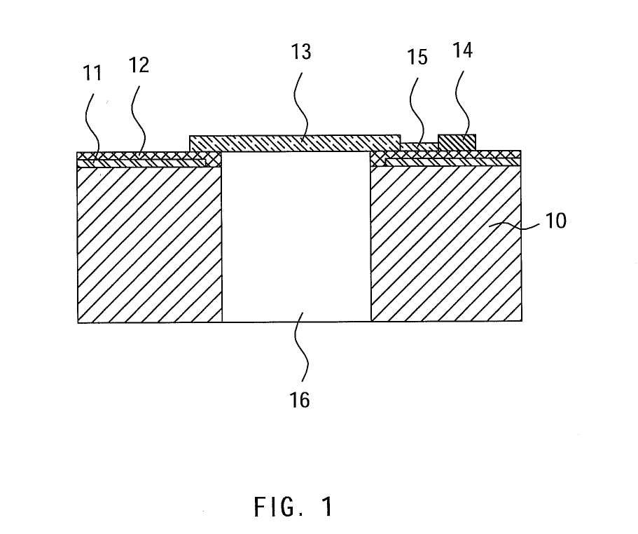

### DETAILED DESCRIPTION OF THE INVENTION

The following description of the preferred embodiments is referring to the accompanying drawings to exemplify specific practicable embodiments of a MEMS microphone chip with an expanded chamber of the present invention.

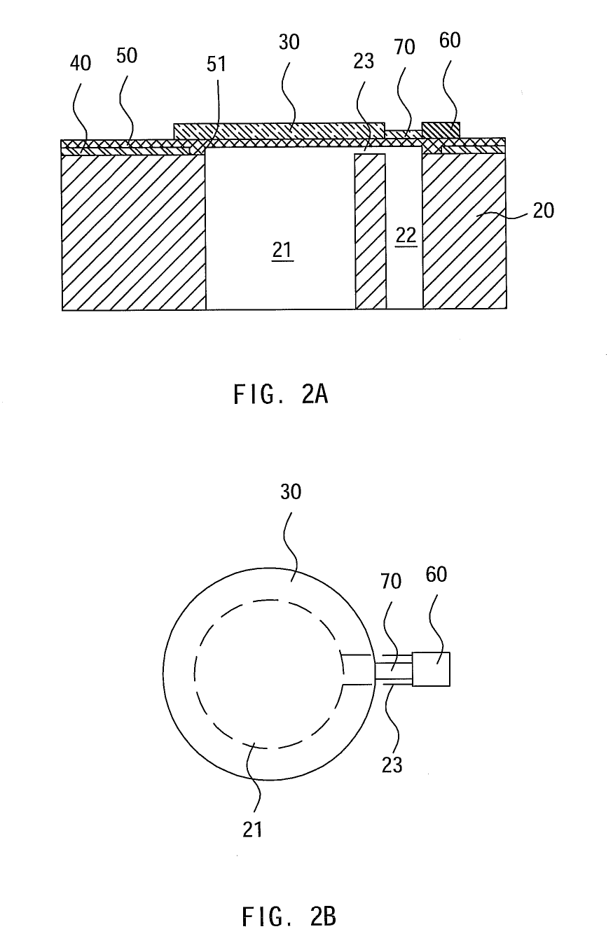

Referring to FIGS. 2A and 2B, they respectively show a cross-sectional view and a top partial transparent view of a MEMS microphone chip of the present invention. The MEMS microphone chip comprises a base plate 20, and the base plate 20 has a main chamber 21 and a secondary chamber 22. The secondary chamber 22 is formed beside the main chamber 21, and the main chamber 21 and the secondary chamber 22 are connected to each other. A vibration membrane 30 is suspended above the main chamber 21 for receiving external sound waves. When the vibration membrane 30 receives external sound waves and vibrates in corresponding to the main chamber 21 and the secondary chamber 22, an electronic signal is correspondingly produced and transmitted to an electronic circuit which is electrically connected to the MEMS microphone chip, in order for the electronic signal to be read.

The same as described above for a conventional one, a MEMS microphone chip of the present invention can be disposed on a bottom plate, and electrically connected to a semi-conductor chip on the same bottom plate. A MEMS microphone is assembled after the bottom plate is fitted with an outer case with sound holes. An electronic signal produced by the vibration of the vibration membrane mentioned above is transmitted to the semi-conductor chip; via the semi-conductor chip, it is then output to a processor of an electronic product installed with the MEMS microphone.

Furthermore, the base plate 20 is made of silicon, and a first insulating layer 40 and a second insulating layer 50 are disposed between the base plate 20 and the vibration membrane 30. The vibration membrane 30 is supported by the second insulating layer 50. The first insulating layer 40 is formed by deposition of silicon dioxides, while the second insulating layer 50 is formed by deposition of silicon nitrides. The base plate 20 can be processed by etching because it is made of silicon. Firstly, two independent grooves are processed and formed in the base plate 20, then the first insulating layer 40 is etched to form a passage 23 between the two grooves, so that the main chamber 21 and the secondary chamber 22 are connected to each other. It is necessary to mention that, when the second insulating layer 50 is deposited on the first insulating layer 40, two boundary columns 51 can be designed and formed in the first insulating layer 40. Therefore, when the first insulating layer 40 is etched, only an area between the two boundary columns 51 is etched. Detailed description of the manufacturing process will be explained in another embodiment accompanying with drawings.

In addition, the base plate 20 further comprises an electrode 60, the electrode 60 is electrically connected to the vibration membrane 30 by a conducting wire 70, and the MEMS microphone chip is electrically connected to the above mentioned semi-conductor chip by the electrode 60. In this embodiment as shown in FIG. 2A, a width of the main chamber 21 is slightly smaller than that of the vibration membrane 30, and the secondary chamber 22 is formed on a periphery projected from the vibration membrane 30. Nevertheless, the width of the main chamber 21 can also be equal to that of the vibration membrane 30, so that the secondary chamber 22 is formed on an area even more away from the vibration membrane 30. However, both ways of arrangement can achieve the same effect. Furthermore, as shown in FIG. 2B, both the main chamber 21 and the vibration membrane 30 are designed in circular shape, and the secondary chamber 22 is formed under the conducting wire 70. Nevertheless, this is only for showing as an example, and the shapes of the chambers 21 and 22 are not limited to be circular, but can be designed according to practical requirements.

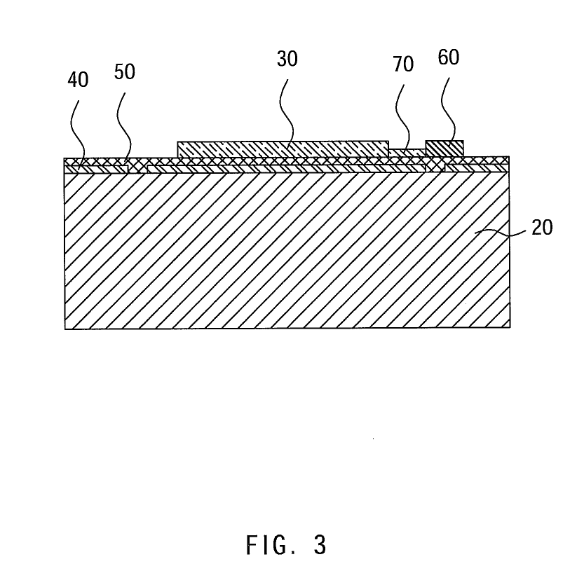

In the following, please refer to FIGS. 3 to 5B, they show manufacturing processes of another embodiment of a MEMS microphone chip of the present invention. Firstly referring to FIG. 3, in this manufacturing process, the base plate 20 made of silicon is provided; the first insulating layer 40 is deposited on the base plate 20; the second insulating layer 50 is deposited on the first insulating layer 40; the vibration membrane 30, the conducting wire 70 and the electrode 60 are formed on the second insulating layer 50. The first insulating layer 40 can be made of silicon dioxides; the second insulating layer 50 can be made of silicon nitrides; the vibration membrane 30 can be made of multi-crystalline silicon; the conducting wire 70 and the electrode 60 can be made of metals with characteristic of electrical conduction.

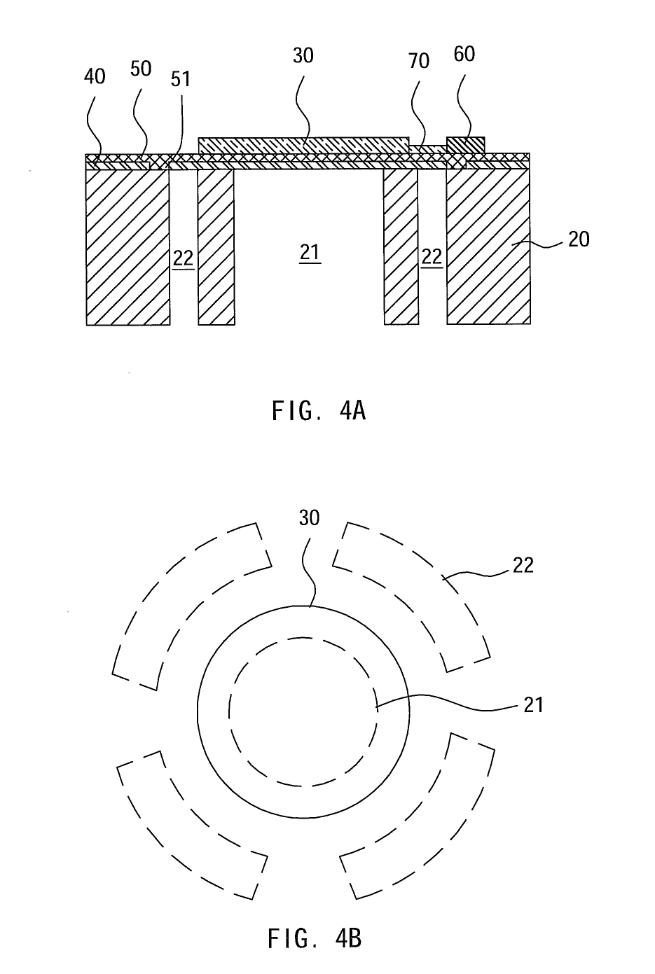

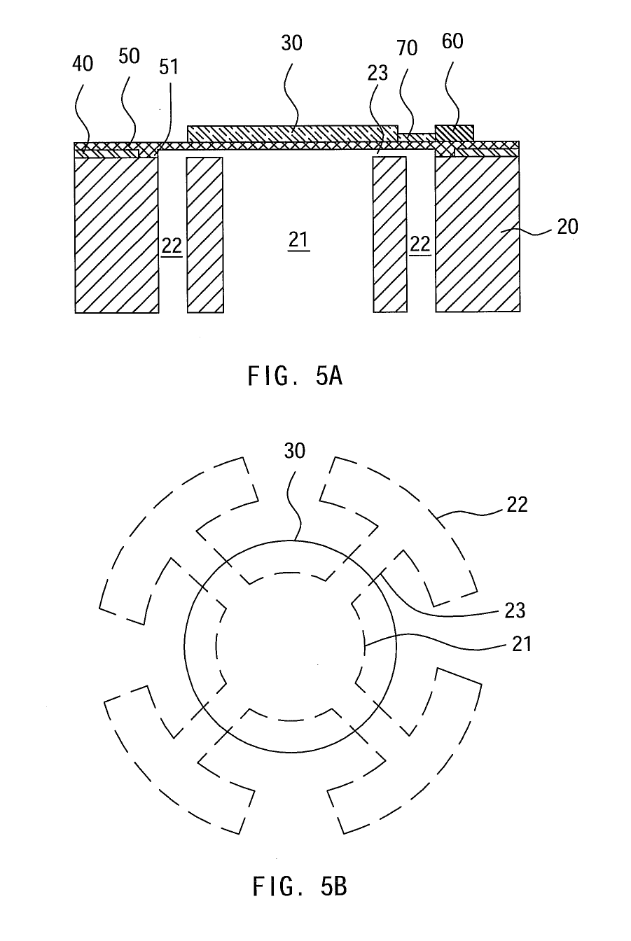

Referring to FIG. 4A, in this embodiment, a large groove and two small grooves are formed by dry etching in appropriate areas in a middle part and by two sides of the base plate 20 respectively; the large groove in the middle can be the main chamber 21, while the two small grooves by the sides can be the secondary chambers 22. As shown in FIG. 4B, in this embodiment, there are four of the secondary chambers 22, and the secondary chambers 22 are in arc shape surrounding the main chamber 21. Referring to FIG. 5A, because the first insulating layer 40 and the second insulating layer 50 are made of different materials, thus the first insulating layer 40 can be etched by plasma which can only have an etching effect on the first insulating layer 40. Furthermore, when the second insulating layer 50 is deposited on the first insulating layer 40, two of the boundary columns 51 can be designed and formed in the first insulating layer 40. Therefore, when the first insulating layer 40 is etched, only an area between the two boundary columns 51 is etched. As shown in FIG. 5B, then the first insulating layer 40 is etched to form the passage 23, so that the main chamber 21 and the secondary chambers 22 are connected to each other. When the vibration membrane 30 vibrates, and because the overall space of the chambers is expanded, thus will show a more ideal audio frequency response characteristic.

In conclusion, a MEMS microphone chip of the present invention is composed of the base plate, the first insulating layer and the second insulating layer disposed below the vibration membrane. By defining the boundary of the chambers beforehand and by the manufacturing process of etching, the main chamber and the secondary chambers are formed and connected to each other on the base plate; therefore, the overall volume of the chambers disposed below the vibration membrane is expanded. In comparing to prior arts, when the vibration membrane of a MEMS microphone chip of the present invention receives external sound waves, the impact by air resistance is reduced substantially and the sensitivity is not easily affected; therefore, it has a more ideal audio frequency response curve.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A MEMS microphone chip with an expanded chamber, comprising:
a base plate having a main chamber and a secondary chamber, the secondary chamber is formed beside the main chamber, and the main chamber and the secondary chamber are connected to each other; and
a vibration membrane suspended above the main chamber;
wherein when the vibration membrane receives external sound waves and vibrates in corresponding to the main chamber and the secondary chamber, an electronic signal is correspondingly produced and is transmitted to an electronic circuit electrically connected to the MEMS microphone chip, in order for the electronic signal to be read.

2. The MEMS microphone chip with an expanded chamber as claimed in claim 1, further comprises a plurality of the secondary chambers disposed by a circumference of the main chamber, and each of the secondary back cavities is connected to the main chamber.

3. The MEMS microphone chip with an expanded chamber as claimed in claim 1, wherein the base plate is made of silicon, the main chamber and the secondary chamber are formed by etching.

4. The MEMS microphone chip with an expanded chamber as claimed in claim 1, further comprises a first insulating layer and a second insulating layer disposed between the base plate and the vibration membrane, the vibration membrane is supported by the second insulating layer.

5. The MEMS microphone chip with an expanded chamber as claimed in claim 4, wherein a passage between the main chamber and the secondary chamber is formed by etching of a part of the first insulating layer.

6. The MEMS microphone chip with an expanded chamber as claimed in claim 4, wherein boundary columns are extended from the second insulating layer to the first insulating layer, so that an area of the first insulating layer being etched can be limited.

7. The MEMS microphone chip with an expanded chamber as claimed in claim 4, wherein the first insulating layer is made of silicon dioxides.

8. The MEMS microphone chip with an expanded chamber as claimed in claim 4, wherein the second insulating layer is made of silicon nitrides.

9. The MEMS microphone chip with an expanded chamber as claimed in claim 1, wherein the base plate further comprises an electrode electrically connected to the vibration membrane, and the MEMS microphone chip is electrically connected to an external electronic circuit by the electrode.

10. The MEMS microphone chip with an expanded chamber as claimed in claim 1, wherein a width of the main chamber is smaller than or equal to a width of the vibration membrane.
